(19) United States
(12) Patent Application Publication
(10) Pub. No.: US 2024/0394773 A1
(43) Pub. Date: Nov. 28, 2024

(54) SYSTEMS AND METHODS FOR VEHICLE RECOMMENDATIONS

(71) Applicant: Capital One Services, LLC, McLean, VA (US)

(72) Inventor: Mark MORRISON, Plano, TX (US)

(73) Assignee: Capital One Services, LLC, McLean, VA (US)

(21) Appl. No.: 18/324,759

(22) Filed: May 26, 2023

(51) Int. Cl. G06Q 30/0601

(52) U.S. Cl. CPC G06Q 30/0631

(57) ABSTRACT

Systems and method for generating vehicle recommendations are determined using interaction information. An information data set may be mapped to a first user and include interactions based on a period of time. The interactions may be parsed by a trained machine learning model to determine trends and attributes. A user profile and a user score for different criteria may be compared to vehicle sores of multiple vehicles. Comparing the scores may identify recommended vehicles for the first user which may be transmitted to a user device of the user.

### TECHNICAL FIELD

Various embodiments of the present disclosure relate generally to techniques for providing vehicle recommendations to users based on user transactions.

### BACKGROUND

Purchasing a vehicle is an important decision for most individuals as it is a significant expense that often requires use of a significant amount of savings or a commitment to a vehicle loan. Because purchasing a vehicle can be a large expense, it is important for a buyer to decide on a vehicle that meets their needs and preferences. If the wrong vehicle is purchased, it cannot simply be returned. Even if a dealer accepts the return of a newly purchased vehicle, the amount refunded is highly discounted as a vehicle that leaves a car dealership is no longer a “new” vehicle, but a “used” vehicle, and the resale value is highly depreciated. In addition, selling a used vehicle may be stressful, result in a lower selling price due to depreciation, and requires time, energy, and effort to post advertisements, accompany test-drives, communicate with potential purchasers, etc.

When purchasing a vehicle, customers are often overwhelmed by the numerous options available and a complex set of criteria to consider, such as price, performance, fuel efficiency, safety, and other bells and whistles. Recommendations from friends or family may be useful, however, individuals have different preferences. For example, what might be important to a parent with four children is likely to be different from what might be important to a college student.

In addition, many customers lack the expertise to make an informed decision and may end up committing a large amount of financial resources for a vehicle that does not fully meet their needs and preferences. Most vehicle purchasers receive vehicle information from skilled sales persons or advertising campaigns, both of which may be biased to a make of a vehicle or are simply interested in making a sale. Other vehicle purchasers may try to simplify the purchase by relying on a limited set of vehicle criteria, such as brand and model, and may not fully capture the complex trade-offs that customers may face when making a vehicle purchase. Overall, vehicle purchasers would benefit from a vehicle recommendation system that provides relevant, unbiased information that is best suited to a customer's needs and preferences.

The present disclosure is, at least in part, directed to overcoming one or more of these above-referenced challenges. However, the above-referenced challenges are provided merely as examples and the claims do not necessarily address any or all of the above-referenced challenges. Furthermore, the disclosure may address challenges not explicitly enumerated in the disclosure. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for transmitting electronic data.

### Summary to be Added Upon Approval

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data. The disclosed systems and methods discussed below may allow advertisers to understand users' online behaviors through the indirect use of raw data and may maintain privacy of the users and the data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for providing vehicle recommendations, according to one or more embodiments.

FIG. 2 depicts another exemplary environment for a vehicle recommendation machine, according to one or more embodiments.

FIG. 3 depicts a flowchart of an exemplary method of providing vehicle recommendations, according to one or more embodiments.

FIG. 4 depicts a flowchart of another exemplary method of providing vehicle recommendations, according to one or more embodiments.

FIG. 5 depicts a flowchart of an exemplary method of providing vehicle recommendations using a machine learning model, according to one or more embodiments.

FIG. 6 depicts an example of a computing device, according to one or more embodiments.

### DETAILED DESCRIPTION OF EMBODIMENTS

Various embodiments of the present disclosure relate generally to techniques for providing vehicle recommendations to users based on user transactions.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” and/or “generally,” are used to indicate a possible variation of ±10% of a stated or understood value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

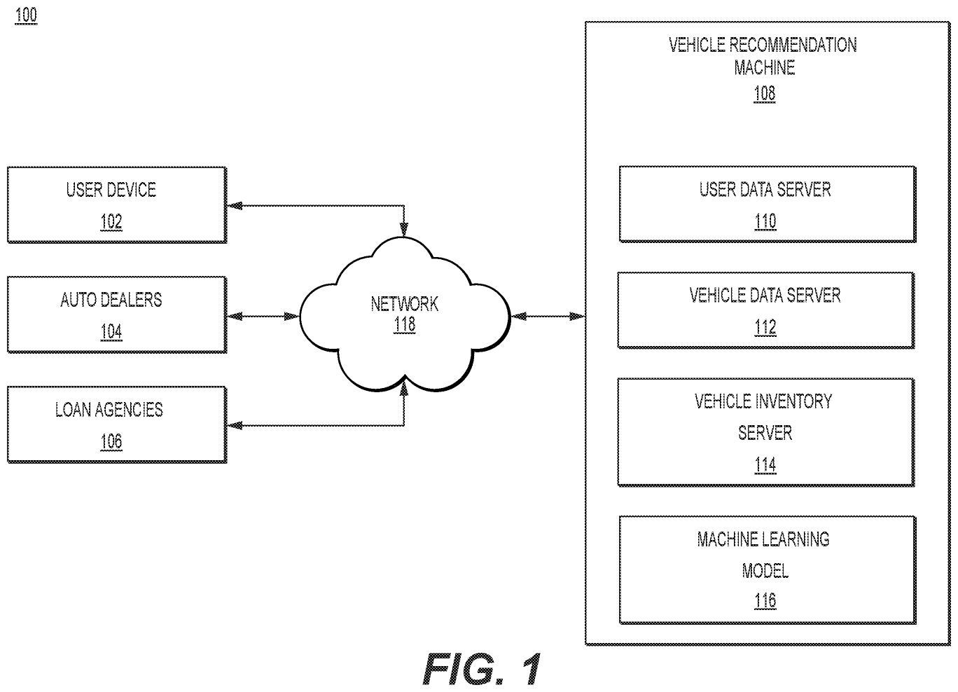

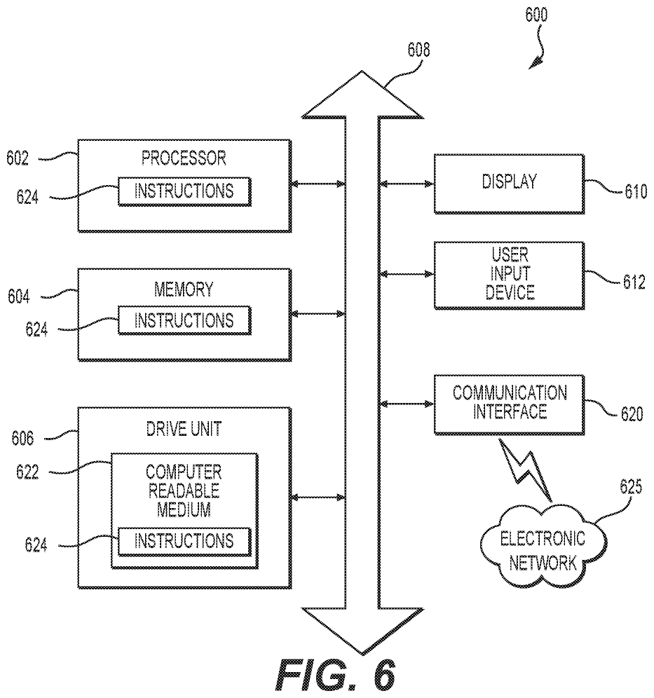

Any suitable system infrastructure may be used to allow a user to receive vehicle recommendations. FIG. 1 and the following discussion provide a brief, general description of a suitable computing environment in which the present disclosure may be implemented. In one embodiment, any of the disclosed systems, methods, and/or graphical user interfaces may be executed by or implemented by an environment consistent with or similar to that depicted in FIG. 1 and/or computer system consistent with or similar to that depicted in FIG. 6. Although not required, aspects of the present disclosure are described in the context of computer-implemented method and/or computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

As shown in FIG. 1, an exemplary environment 100 may be implemented for providing vehicle recommendations, according to one or more embodiments. The environment 100 may include user device 102, such as a computer or smart phone. User device 102 may be able to store, process, and transmit data and receive information. User device 102 may receive inputs from a user or display information using a graphical user interface (GUI).

An exemplary embodiment of the environment may also include auto dealers 104 that sell used and new automobiles. Auto dealers 104 may be model specific, such as a Ford or Honda dealer, or may be an auto dealer that sells all types of vehicle makes and models. Loan agencies 106 may include financial institutions that are in the business in providing auto loans and may include banks, credit unions, loan centers, etc.

User device 102, auto dealers 104, and loan agencies 106 may receive and/or transmit data to/from vehicle recommendation machine 108 over network 118. At a high level, vehicle recommendation machine 108 may analyze data and information to determine vehicle recommendations. Information that is analyzed may be stored in one or more servers including, for example, user data server 110, vehicle data server 112, vehicle inventory server 114, and machine learning model 116.

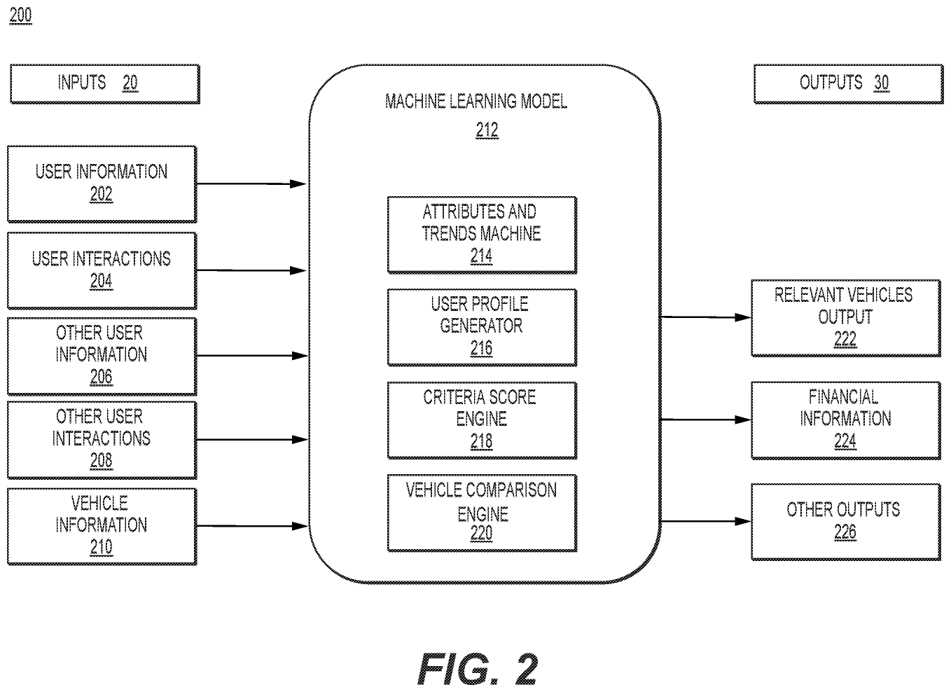

FIG. 2 depicts an exemplary environment 200 for providing vehicle recommendations, according to one or more embodiments. At a high level, the environment 200 may include a machine learning model 212 that receives inputs 20 and provides outputs 30.

Inputs 20 may include user information 202, user interactions 204, other user information 206, other user interactions 208, and/or vehicle information 210. User information 202 may include information related to a user profile that includes details related to a user. User information 202 may include contact information (e.g., address, phone number, or email address), vehicle purchase history, the user's preferences (e.g., vehicle preferences, lifestyle preferences, etc.), demographic information (income, ethnicity, and age), occupation, education level, user credit score information, or the like or a combination of the same.

User interactions 204 may include data provided by financial institutions, such as banks, credit card companies, credit unions, loan agencies, etc. User interactions 204 may include one or more purchase characteristics (e.g., data fields) relating to a transaction. Purchase characteristics may include, but are not limited to, a product (i.e., a good or service) name, merchant name, merchant location, transaction date, transaction time, transaction identification number, transaction amount, merchant identification number, merchant category code, product description, transaction description, an image, and more. User interactions 204 may be stored in user data server 110 as associated with an account profile for a user.

Other inputs 20 may include other user information 206. Similar to user information 202, other user information 206 may include user profiles for multiple other users that includes details related to each such other user's corresponding user information. Other user information 206 may include different types of contact information (e.g., address, phone number, or email address), vehicle purchase histories, user preferences, demographic information (income, ethnicity, and age), occupation, education level, user credit score information, and so forth.

Other user information 206 may also correspond to other user interactions 208. As with user interactions 204, data of the other user interactions may be provided by one or more of banks, credit card companies, credit unions, loan agencies, etc. The other user interactions 208 may include one or more purchase characteristics (e.g., data fields) relating to a transaction associated with the other users. The purchase characteristics may include, but are not limited to, a product (i.e., a good or service) name, merchant name, merchant location, transaction date, transaction time, transaction identification number, transaction amount, merchant identification number, merchant category code, product description, transaction description, an image, and more. Other user interactions 208 may also be stored in user data server 110 and correspond to an account profile for the other user that participated in the user interaction.

Another input may include vehicle information 210. Vehicle information 210 may be provided by one or more sources or may be provided by vehicle makers, car dealerships, insurance underwriters, and/or vehicle review websites. Vehicle information 210 may include information related to safety features, such as airbags, anti-lock brakes, electronic stability control, and/or any additional safety options. Vehicle information 210 may be related to fuel economy, such as gas mileage, any hybrid or electric powertrain options, or environmental impact. Information may also include the vehicle's maintenance and repair history if it is a used vehicle, and/or scheduled maintenance and warranty information in instances where a vehicle is new. Vehicle information 210 may include reliability ratings, estimated resale value, size, and towing or storage capacity. In addition, vehicle information 210 may include technology features such as infotainment systems and driver-assist features. Vehicle information 210 may also include an overall cost, a purchase price and any projected financing, insurance, and/or operating costs. Other vehicle information may include any information that may be of importance for a perspective buyer.

Vehicle information 210 may also include financial information related to vehicles. While this information may be price related, such as sticker price, manufacturer suggested retail price (MSRP), loan information. Loan information may be for a specific vehicle on the market. Alternatively, loan information may be estimates based on information provided by banks, lenders, insurance companies, and/or other financial institutions.

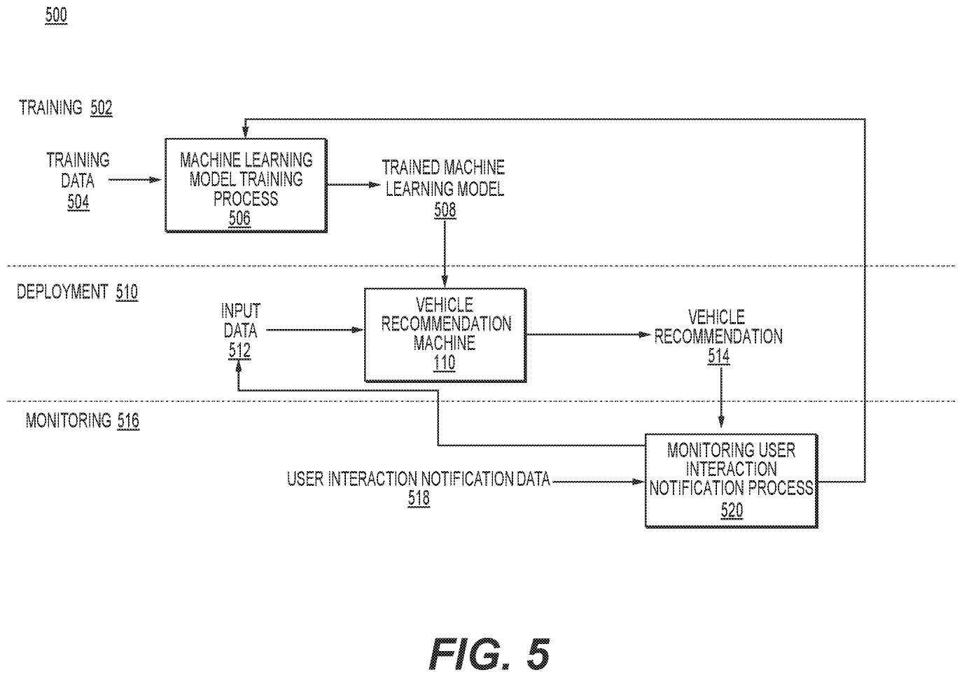

Machine learning model 212 may be based on the exemplary embodiments discussed below in reference FIG. 5, and may include an attributes and trends machine 214, a user profile generator 216, a criteria score engine 218, and a vehicle comparison engine 220.

Machine learning model 212 may receive inputs 20 and may utilize an attributes and trends machine 214 to output attributes and trends associated with a user. The attributes and trends may be based on user information 202, user interactions 204, other user information 206, and/or other user interactions 208. Attributes may be related to the user interactions 204 and other user interactions 208 such that each user interaction may provide one or more attributes related to the user interaction. For example, attributes may be location related, such as where the item was delivered or shipped, or the purchase location such as the location of a store or the location of a website. Attributes may include an amount or category. As an example, attributes related to a user interaction involving a purchase of monster energy drinks may include that the user spent $20.00 for a 24 pack and may categorize the user interaction as groceries. Attributes may be associated with a tier level. For example, a purchase of a designer hand bag may be labeled as a higher tier attribute in comparison to a hand bag purchased at a thrift store, which may be labeled as a lower tiered attribute. Many different attributes may be associated with interactions. The tier level may be based on one or more of a product type, a product price, a purchase location, a discount amount, and/or the like.

Trends may be determined by attributes and trends machine 214. Machine learning model 212 may analyze interaction data and attributes data to output trends related to a user. For example, attributes and trends machine 214 may recognize that a threshold number or percent of interactions for a user are associated with premium products that have the attribute of belonging to a top tier. Accordingly, a determined trend for the user may indicate that the user prefers premium products. In another example, a user may have many interactions that are routine or habitual. A user may have an interaction every Thanksgiving that includes the purchase of a ski pass and gas station purchases close to snow resorts during the months of November through March. A trend might be determined that during the winter, the user spends significant travel time driving to ski resorts. Trends may also be related to travel distance. For example, a user may have an interaction every weekday around 7:00 am at a local coffee shop, and another interaction around 7:00 pm that is paid to Metropolitan Transportation Authority (MTA) in Washington Heights, New York. Machine learning model 212 may determine, based on this information and user information including a home address in Manhattan (close to the coffee shop), that these transactions have attributes of work week transportation interactions. Using this information machine learning model 212 may be able to determine that the coffee shop interactions indicate when the user is beginning her morning commute and that the interaction with MTA transit authority is a toll to cross back over the George Washington Bridge to get home after work. This information may result in machine learning model 212 to identify trends related to work commute, daily travel distance, hours spent at work, driving type (highway or traffic), or other trends. Other trends may be extrapolated by analyzing user interactions and attributes. For example, machine learning model 212 may establish trends that include travel type, amount of time traveled, frequent or routine destinations, average number of passengers, age of average passenger, etc.

Machine learning model 212 may also include a user profile generator 216. By comparing user information 202 and user interactions 204 with other user information 206 and other user interactions 208, a user profile may be generated. Machine learning model 212 and/or user profile generator 216 may be trained to output user profiles based on historical or simulated user information and/or user interactions and their respective historical or simulated user profiles. For example, a user profile generator may receive user information that includes an age of 22, a non-married marital status, a home address close to a college campus, a different address when school is not in session, and interactions that include frozen pizzas, meatballs, energy drinks and video game downloads, and determine from the information and other related individuals that this user is most relatable to a male college bachelor profile. Alternatively, for a user that includes user information such as an age of 29, a married marital status, and user interactions that include diapers, baby food, and baby wipes, machine learning model 212 may determine that this user most closely fits the young parent profile. The number of profiles are not limited to these two examples as numerous profiles may be determined, created, and updated based on machine learning model 212 analyzing user information 202, user interactions 204, other user information 206, and other user interactions 208. Each profile of the number of profiles may be associated with a profile identifier.

Machine learning model 212 may also include criteria score engine 218. Criteria score engine may determine, from user information 202 and user interactions 204 in comparison with other user information 206 and other user interactions 208, user criteria scores and vehicle criteria scores for categories, features, or vehicle characteristics. Machine learning model 212 and/or criteria score engine 218 may be trained to output user and vehicle criteria scores based on historical or simulated categories, features, or vehicle characteristics and their respective historical or simulated user and vehicle criteria scores. The user and vehicle criteria scores may be a number ranking or a hierarchal ranking or any other form of comparison. For example, a criteria with a high score (e.g., above a criteria threshold) may indicate a high importance or high value for the user. In an example including a user with a college bachelor profile, criteria score engine 218 may analyze the user information 202 and user interactions 204 to determine the user has high user criteria scores for aesthetics, acceleration, a premium sound system, and affordability. The same user may also have low user criteria scores for safety, towing capacity, and gas mileage, indicating that these criteria are not as important to the user with a college bachelor profile. In another example, the user with the young parent profile may have high user criteria scores for safety, automatic sliding doors, car seat room, and passenger capacity, indicating a high level of importance. The same user may also low user criteria scores for sound system, tinted windows, and top speed, as these criteria may not be as important to the user, based on the user profile.

Criteria score engine 218 may determine numerous other criteria and user criteria scores for many different user profiles and using user information and interaction data. Alternatively, a user may provide feedback, via a GUI, as to their user criteria scores for certain criteria. For example, a user may be provided with an electronic form or survey to fill out and provide an indication of their user criteria scores for certain criteria. The form or survey may include opportunities to rank or score certain features of cars which would be used to determine user criteria scores for the user. Alternatively, a combination of user entered scores and user criteria scores determined by machine learning model 212 may be employed.

Machine learning model 212 may also include vehicle comparison engine 220. Vehicle comparison engine 220 may utilize vehicle information 210 to determine vehicle criteria and vehicle criteria scores for each vehicle. Machine learning model 212 and/or user vehicle comparison engine 220 may be trained to output vehicle criteria scores and/or vehicle criteria based on historical or simulated vehicle information and respective historical or simulated vehicle criteria scores and/or criteria. For example, vehicle comparison engine may determine that a Kia Optima™ may receive a high score for a criteria of safety because vehicle information 210 includes third party reviews where the Kia Optima™ performed well on crash tests. In this instance, a high score for safety may be based on a score, such as “93” out of “100,” or “9” out of “10” stars. Alternatively, a high vehicle criteria score may be a ranking, such as 1^{st} out of 30other 4-door sedans. Many vehicle criteria may be determined by vehicle comparison engine 220. A non-exhaustive list of vehicle criteria may include safety, capacity, storage, gas mileage, towing capacity, looks, comfort, control, steering, warranty, maintenance, features, maximum driving distance, eco-friendly, assisted steering, crash detection, crash avoidance, child friendly, etc. A vehicle criteria may directly correspond with a user criteria. For example, a vehicle criteria of low maintenance may correspond with a user criteria of low maintenance. A vehicle criteria may also indirectly correspond with a user criteria. For example, a vehicle criteria of crash avoidance may indirectly correspond with a user criteria of safety.

Machine learning model 212 may produce a variety of outputs 30 including relevant vehicles output 222, financial information 224 (e.g., auto-loan information), or other outputs 226. Relevant vehicles output 222 may include a single or group of vehicles that are recommended to the user based on the information provided to and the determination of machine learning model 212. The information may also include vehicle criteria scores of the relevant vehicles. Additionally, the recommended vehicles output may include information about the vehicle, such as price, features, and specifications. Other information may include the locations or dealerships where the recommended vehicle is located. Using a location tracking device, such as a global positioning system (GPS), the recommended vehicle information may also display a map of the recommended vehicles and directions to the recommended vehicles that include an estimated drive time. In instances where the recommended vehicle is at a dealership, relevant dealership information may also be displayed. For example, machine learning model 212 may determine that a recommended vehicle is a Toyota Tacoma™ and that there are 5 located at 3 different dealerships within a 50 mile radius. Information may include that it would take 25 minutes to get to the closest dealer and that the dealer is open from 9 o'clock in the morning and closes at 6 o'clock in the evening.

In another embodiment, the vehicle criteria scores of relevant vehicles may be provided to the user along with the user criteria score so that the user may be able to see why the provided vehicles were recommended. In the exemplary embodiment of the Toyota Tacoma™, the vehicle information for the Toyota Tacoma™ may include a score of “95” for resale value, “50” for gas mileage, and “72” for towing ability. If the user criteria scores were displayed along with the vehicle criteria score, the vehicle comparison engine 220 may also include that the user had an 85 for resale value, “60” for gas mileage, and “65” for towing ability. By being provided the vehicle criteria scores and the user criteria scores, the user may be able to understand why the vehicle was recommended.

Another output may include financial information 224. Based on the relevant vehicles output 222, machine learning model 212 may provide the user with information related to financing options. While self-financing information may be provided and include the purchase price or MSRP of the vehicle, other financing information provided may relate to loans, interest rates, or monthly payments. This loan information may be a general estimate for a specific vehicle, or it may be a specific offer tailored to the user and based on the user information 202 and user interactions 204.

In one exemplary embodiment, generic loan information may provide to the user a general estimate for a loan based on a recommended vehicle. For example, a recommended vehicle that is priced at $35,000 might also include financial information 224 for the user to expect a $35,000 loan with 0% down to cost about $500 a month for 7 years at a 5.4% interest rate. In this exemplary embodiment, a link may be provided to the user to opt into transferring data including the specific vehicle and loan amount to financial institutions as a contact lead generator and a way for the user to quickly receive a loan quote.

In another exemplary embodiment, a financial institution may provide loan information as part of vehicle information 210 giving authorization to extend a loan offer to users who meet loan requirements of the financial institution. As an example, Financial Bank ABC may provide vehicle information 210 that includes authorization for a loan offer corresponding to a specific vehicle and sale price. This offer may be limited to user's who have a credit score of “750” or above. Machine learning model 212 may send this information as a pre-approval offer letter or offer email to the user's inbox or street address provided with user information 202 if machine learning model 212 determines that user has a credit score of “775.”

Financial information 224 may also include clearance or sale information, such as a holiday special or a year end clearance. Financial information 224 may also provide an indication that the vehicle for sale is overpriced or underpriced and provide comparisons that might be better for the user, or to inform the user of alternative options. Financial information 224 may also include trends, such as identifying an unusual price increase for used cars as logistics and materials created issues for automobile manufacturers during a worldwide pandemic. A variety of financial information 224 may be provided to a user and correlated with relevant vehicles output 222.

Outputs 30 may include other outputs 226 One other output may be a share button that would allow for the quick sharing of a recommended vehicle. In one example embodiment, data and information associated with an output (e.g., a vehicle recommendation) may be packaged into a link that can be copied and pasted, or selection of the button may open a dialogue box on a GUI that allows for an destination (e.g., email address or phone number) to be entered. Entering the destination may then send the packaged data relating the recommended vehicle and/or financing information.

In another example, other outputs 226 may include an opt-in button displayed on a GUI of a user device where pushing the opt-in button would instantly connect a user to receiving further information from a dealer, auto-maker, or additional information related to a specific recommended vehicle.

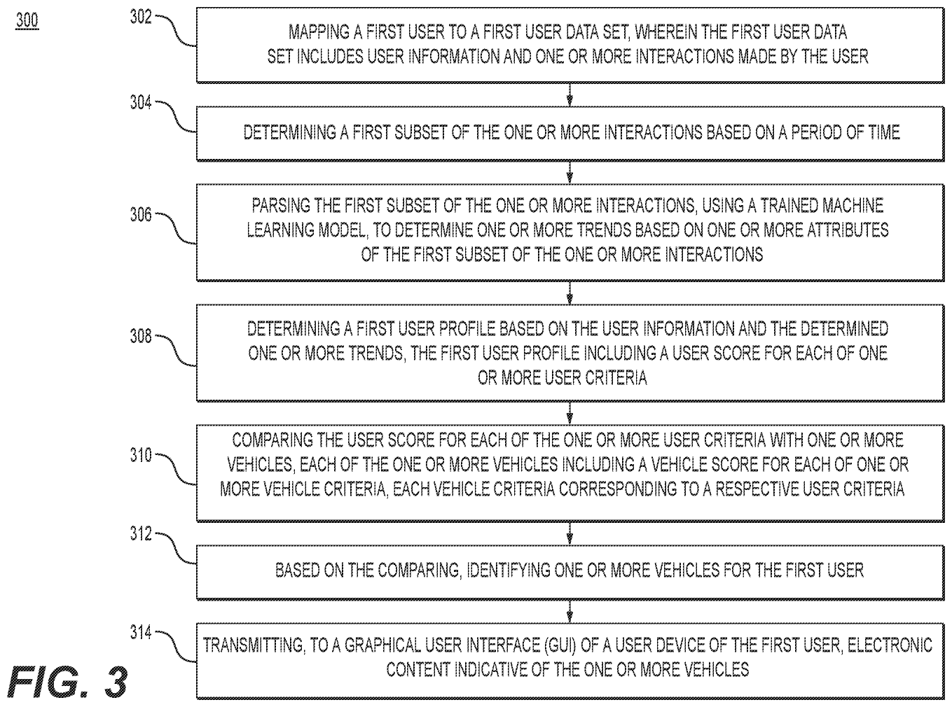

FIG. 3 depicts a flowchart of an exemplary method 300 of providing vehicle recommendations, according to one or more embodiments. In an example embodiment, step 302 may include mapping a first user to a first user data set, wherein the first user data set includes user information and one or more interactions made by the user. Mapping a first user to a first user data set may be based on identifiers and verification (e.g., user names, account numbers, passwords, authentication tokens, etc.). Mapping a first user to a first user data set may include associating user information (e.g., email address, payment method, order identifier, loyalty program account, mobile device identifier, etc.) from a data set to a user. While a user data set may include user information, a user data set may also include information that is input or modified by the user. For example, user information may include location data and user preference data gathered from a user data set, however, a user may also manually input the location and preference data, or may modify the data set information as they see fit.

Step 304 may include determining a first subset of the one or more interactions based on a period of time. As an example, a financial institution, user data server 110, user information 202 component, and/or user interactions 204, may utilize data related to transactions and purchases for services and products associated with a user, as provided in the first user data set, and may filter the transactions and purchases to only those made within the last three years.

Step 306 may include parsing the first subset of the one or more interactions, using a trained machine learning model, to determine one or more trends based on one or more attributes of the first subset of the one or more interactions. For instance, attributes may include a location, amount, category, or tier. Trends may include travel time, travel distance, travel type, and/or travel routine. Other attributes and trends may be determined by a trained machine learning model such as the one described herein. In one exemplary embodiment, the one or more interactions associated with the user are continuously updated and parsed in real-time by the trained machine learning model. Accordingly, trends and/or attributes associated with a user may be iteratively updated based on updated user interactions

Step 308 may include determining a first user profile based on the user information and the determined one or more trends, the first user profile including a user score for each of one or more user criteria. As an example, after analyzing user information including user profile information and interaction information, along with the determined trends, a user may be associated with a user profile having a user profile identifier. The user profile may be selected from one of a plurality of pre-determined profiles. Alternatively, a new user profile associated with the user may be generated and may include user criteria scores for a plurality of criteria. For example, a user may be associated with a user profile corresponding to a retired professional. The user may be associated with the retired professional profile based on the corresponding interaction information including donations to a graduate school, payments for rounds of golf, trips throughout the year, and doctor bills associated with individuals generally being of a retirement age. For this user with the “retired professional” profile, some user criteria scores may include high scores for criteria such as convertible, luxury, and comfort. In this example, the user profile for a “retired professional” may include a user score “100” for convertible, indicating a requirement for a convertible, and user criteria scores of 93and “95” for luxury and comfort, respectively.

Step 310 may include comparing the user score for each of the one or more user criteria with one or more vehicles, each of the one or more vehicles including a vehicle score for each of one or more vehicle criteria. In this step, machine learning model 212 may utilize the input information and compare the user criteria scores with respective vehicle criteria scores for a plurality of different vehicles.

Step 312 may include, based on the comparing, identifying one or more vehicles for the first user. In the example of the user with a retired professional profile, the user criteria scores of “100” for convertible (meaning the car must be a convertible), “93” for luxury, and “95” for comfort may identify one or more vehicle recommendations. For example, a BMW™ 4 Series convertible may be recommended as the vehicle criteria scores for a BMW™ 4 Series convertible may include “100” for convertible (since the car is a convertible), a “92” for luxury, and a “93” for comfort. Other vehicles may also be recommended that have vehicle criteria scores that closely match the user criteria scores. In one embodiment, a machine learning model may output vehicle recommendations based on user criteria scores, vehicle criteria scores, and internal thresholds for determining vehicle recommendation matches based on historical and/or simulated user and vehicle criteria scores.

Step 314 may include transmitting, to a user (e.g., via a user device, a GUI of a user device of the first user, etc.), electronic content indicative of the one or more vehicles identified at step 312. The electronic content may include vehicle information, location, price, dealership information, features, etc. The one or more vehicles may be arranged by recommendation, with the most recommended vehicle appearing at the top of the GUI and the least recommended vehicle at the bottom of the GUI. Continuing the previous example, the BMW™ 4 Series convertible may be ordered at the top of a GUI, with other vehicles with lower correlations to the user's user criteria scores displayed below, with the vehicle having the lowest correlation ordered at the bottom. The electronic content may be re-ordered based on updated user information and/or user interactions, based on updated machine learning outputs, as discussed herein. The electronic content including the vehicle recommendations may also be sorted by price, location, driver satisfaction, safety, or other criteria. The user may provide an indication (e.g., via input to a GUI presented using a user device) how the results should be sorted and may indicate information preferences for what is displayed.

In another exemplary embodiment, the method 300 may include repeating steps 302-314 based on updated user information and/or updated user interactions. For example, a user may receive updated results periodically (e.g., every two months, every day, etc.) or based on receiving updated user information and/or updated user interactions. In this example, updated user information and/or updated user interactions may analyzed to determine updated attributes and trends that may be used to identify updated vehicle recommendations. In another exemplary embodiment, the method 300 may include receiving a request from the user to receive the electronic content indicative of the one or more vehicles transmitted to the user device of the first user. This may be similar to an opt-in preference of the user that is indicated through the GUI of a user device.

In another exemplary embodiment, the method 300 may include analyzing the identified one or more vehicles for the first user and the user information to determine one or more interaction suggestions. For example, after analyzing a user's interactions, the method may determine that attributes of the interactions include eco-friendly purchases. These attributes may lead to identified trends and result in one or more vehicle recommendations for electric vehicles. Based on this information, the method may determine an interaction suggestion for the user, such as upgrading a breaking system to regenerative breaking, so as to promote sustainability. Another exemplary embodiment may include generating an interaction suggestion based on the one or more recommended vehicles, For example, the interaction suggestion may provide an option to share the identified one or more vehicles with a second user. In an exemplary embodiment, upon receiving an instruction from a first user (e.g., via a GUI input) to share the one or more recommended vehicles with the second user, sending data information of the one or more vehicle recommendation to the second user.

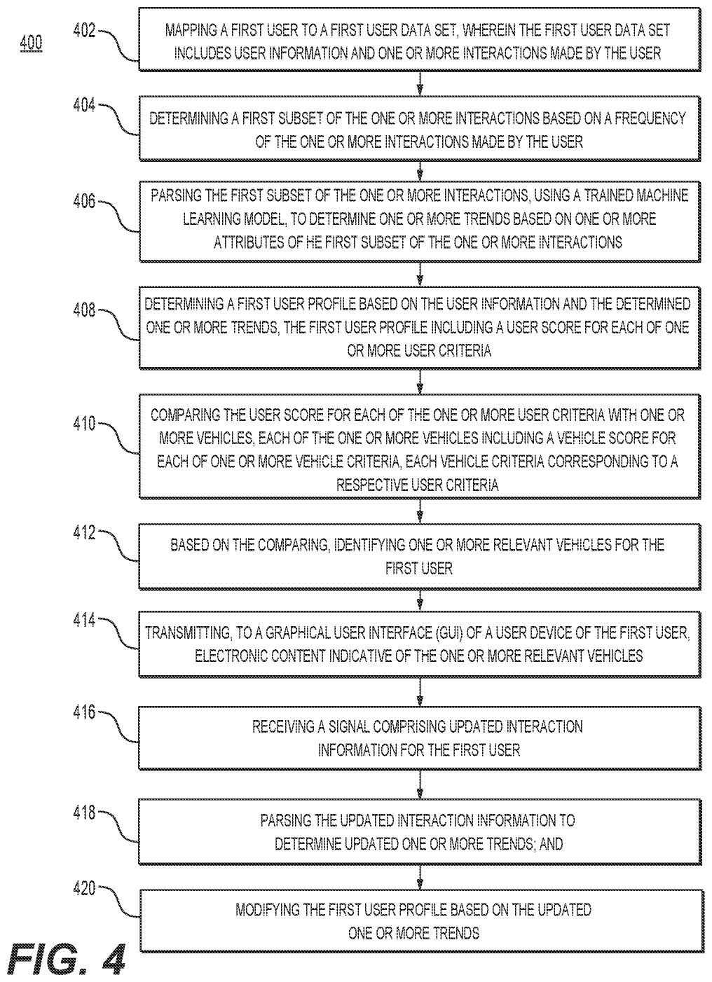

FIG. 4 depicts a flowchart of another exemplary method 400 of providing vehicle recommendations, according to one or more embodiments. In an exemplary embodiment, step 402 may include mapping a first user to a first user data set, wherein the first user data set includes user information and one or more interactions made by the user.

Mapping a first user to a first user data set may be based on identifiers and verification (e.g., user names, account numbers, passwords, authentication tokens, etc.). Mapping a first user to a first user data set may include associating user information (e.g., email address, payment method, order identifier, loyalty program account, mobile device identifier, etc.) from a data set to a user. While a user data set may include user information, a user data set may also include information that is input or modified by the user. For example, user information may include location data and user preference data gathered from a user data set, however, a user may also manually input the location and preference data, or may modify the data set information as they see fit.

The data set may include data packets transmitted from third party entities and the one or more interactions may include transactional purchases of items or services. User information may include information of the user such as contact information, user demographics, and may also include financial information such as credit limits or credit ratings.

Step 404 may include determining a first subset of the one or more interactions based on a frequency of the one or more interactions made by the user. As an example, a financial institution, user data server 110, user information 202 component, and/or user interactions 204, may utilize data related to transactions and purchases for services and products associated with user, as provided in the first user data set, and may filter the transactions and purchases to only those that are made more than 5 times in the last 6 months.

Step 406 may include parsing the first subset of the one or more interactions, using a trained machine learning model, to determine one or more trends based on one or more attributes of the first subset of the one or more interactions. For instance, attributes may include a location, amount, category, or tier. Trends may include travel time, travel distance, travel type, or travel routine. Other attributes and trends may be determined by a trained machine learning model such as the one that will be described herein. In one exemplary embodiment, the one or more interactions associated with the user are continuously updated and parsed in real-time by the trained machine learning model. Accordingly, trends and/or attributes associated with a user may be iteratively updated based on updated user interactions.

Step 408 may include determining a first user profile based on the user information and the determined one or more trends, the first user profile including a user score for each of one or more user criteria. As an example, after analyzing user information including user profile information and interaction information, along with the determined trends, a user may be categorized as a retired lawyer because many of the interaction information includes payments for rounds of golf, trips throughout the year, and doctor bills associated with high age. For this user with the “retired lawyer” profile, some user criteria scores may include high scores for criteria such as convertible, luxury, and comfort. In this example, the user having a “retired lawyer” profile may score “100” for convertible, meaning the car must be a convertible, and a “93” and “95” for luxury and comfort, respectively.

Step 410 may include comparing the user score for each of the one or more user criteria with one or more vehicles, each of the one or more vehicles including a vehicle score for each of one or more vehicle criteria. In this step, the power of machine learning model 212 is able to utilize all the input information and compare all the user criteria scores with vehicle criteria scores for many different vehicles.

Step 412 may include, based on the comparing, identifying one or more relevant vehicles for the first user. In the exemplary embodiment of the user with a retired lawyer profile, the user criteria scores of 100 for convertible (meaning the car must be a convertible), 93 for luxury, and 95 for comfort may identify one or more vehicle recommendations. For example, a BMW™ 4 Series convertible may be recommended as the vehicle criteria scores for a BMW™ 4 Series convertible may include 100 for convertible (since the car is a convertible), a 92 for luxury, and a 93 for comfort. Other vehicles may also be recommended that have vehicle criteria scores that closely match the user criteria scores. Another embodiment may include repeating the identifying the one or more vehicles and the transmitting the electronic content indicative of the one or more vehicles occurs at periodic intervals. For example, identifying one or more vehicles may occur at every beginning of the month.

Step 414 may include transmitting, to a graphical user interface (GUI) of a user device of the first user, electronic content indicative of the one or more relevant vehicles. The electronic content may include vehicle information, location, price, dealership information, features, etc. The one or more vehicles may be sorted by recommendation. In this exemplary embodiment, the BMW™ 4 Series convertible would be at the top with other less correlative vehicles displayed below with the least correlative recommendation at the bottom of the display. The electronic content including the vehicle recommendations may also be sorted by price, location, driver satisfaction, safety, or other criteria. The user may indicate on the GUI of the user device how the results should be sorted and may indicate information preferences for what is displayed.

Step 416 may include receiving a signal comprising updated interaction information for the first user. Continuing the previous example, a user associated with a profile for a “retired professional” may subsequently purchase diapers, baby food, and a pack-and-play crib set. Step 418 may include parsing the updated interaction information to determine updated one or more trends. In this example, parsing the interaction information related to the baby purchases may be used to determine an updated trend of visits to child friendly locations. Step 420 may include modifying the first user profile based on the updated one or more trends. Continuing the example, the user profile of “retired professional” may be updated, based on the updated trends, to “retired grandparent.”

In another exemplary embodiment, the method 400 may include repeating steps 402-420 based on updated user information and/or updated user interactions. For example, a user may receive updated results periodically (e.g., every two months, every day, etc.) or based on receiving updated user information and/or updated user interactions. In this example, updated user information and/or updated user interactions may analyzed to determine updated attributes and trends that may be used to identify updated vehicle recommendations. In another exemplary embodiment, the method 400 may include receiving a request from the user to receive the electronic content indicative of the one or more vehicles transmitted to the user device of the first user. This may be similar to an opt-in preference of the user that is indicated through the GUI of a user device.

In another exemplary embodiment, the method 400 may include analyzing the identified one or more vehicles for the first user and the user information to determine one or more interaction suggestions. For example, after analyzing a user's interactions, it may be determined that attributes of the transactions include eco-friendly purchases. These attributes may lead to identified trends and result in one or more vehicle recommendations for electric vehicles. Based on this information, the method may determine an interaction suggestion for the user, such as upgrading a breaking system to regenerative breaking, so as to promote sustainability. Another exemplary embodiment may include the interaction suggestion being to share the identified one or more vehicles with a second user.

In another exemplary embodiment, upon receiving from the user and via the GUI an instruction to share the indicated one or more vehicles with the second user, sending data information of the one or more vehicle recommendation to the second user.

As depicted in FIG. 5, in some examples, the process 500 may include a training phase 502, a deployment phase 510, and a monitoring phase 516. In the training phase 502, at step 506, the process 500 may include receiving and processing training data 504 to generate (e.g., build) a trained machine learning model 508 for determining a vehicle recommendation.

The training data 504 may include historical and/or simulated vehicle recommendations associated with a plurality of user accounts. The accounts may include accounts of other users and/or the account of the user. The training data 504 may be generated, received, or otherwise obtained from internal and/or external resources. For example, the training data 504 may include historical vehicle recommendations data associated with one or more accounts provided by the user device 102, the data being collected and stored by the user data server 110 of the vehicle recommendation machine 108. Additionally, or alternatively, the training data 504 may include historical vehicle recommendations associated with one or more accounts provided by auto dealers 104 or loan agencies 106 that grants access to their data. In such examples, the accounts provided by the auto dealers 104 or loan agencies 106 may be of a similar type to the accounts provided by the user. In some examples, vehicle recommendations may be based on trends that are determined from attributes of user interactions. For example, attributes of a user interaction may include one or more of location, amount, category, or tier. Trends may include travel time, travel distance, travel type, or travel routine.

Generally, a model includes a set of layers or variables, e.g., nodes, neurons, filters, etc., that are tuned, e.g., weighted or biased, to different values via the application of the training data 504. In some examples, the training process at step 506 may employ supervised, unsupervised, semi-supervised, and/or reinforcement learning processes to train the model (e.g., to result in trained machine learning model 508). In some embodiments, a portion of the training data 504 may be withheld during training and/or used to validate the trained machine learning model 508.

When supervised learning processes are employed, labels or scores corresponding to vehicle purchase recommendations (e.g., labels, rankings, or scores corresponding to the training data) may facilitate the learning process by providing a ground truth. For example, the labels or scores may indicate the optimal vehicle purchase recommendation. Training may proceed by feeding historical vehicle purchase recommendation data for a series of user interactions (e.g., purchases) from the training data into the model, the model having variables set at initialized values, e.g., at random, based on Gaussian noise, a pre-trained model, or the like. The model may output a predicted optimal eco-friendly purchase recommendation for the sample. The output may be compared with the corresponding label or score (e.g., the ground truth) to determine an error, which may then be back-propagated through the model to adjust the values of the variables. This process may be repeated for a plurality of samples at least until a determined loss or error is below a predefined threshold. In some examples, some of the training data 504 may be withheld and used to further validate or test the trained machine learning model 508.

For unsupervised learning processes, the training data 504 may not include pre-assigned labels, rankings, or scores to aid the learning process. Rather, unsupervised learning processes may include clustering, classification, or the like to identify naturally occurring patterns in the training data 504. K-means clustering or K-Nearest Neighbors may also be used, which may be supervised or unsupervised. Combinations of K-Nearest Neighbors and an unsupervised cluster technique may also be used. For semi-supervised learning, a combination of training data 504 with pre-assigned labels or scores and training data 504 without pre-assigned labels or scores may be used to train the model.

When reinforcement learning is employed, an agent (e.g., an algorithm) may be trained to make a decision regarding the optimal vehicle recommendation for the sample from the training data 504 through trial and error. For example, upon making a decision, the agent may then receive feedback (e.g., a positive reward if the predicted vehicle recommendation was the actual vehicle recommendation that was determined), adjust its next decision to maximize the reward, and repeat until a loss function is optimized.

Once trained, the trained machine learning model 508 may be stored and subsequently applied by the vehicle recommendation machine 108 during the deployment phase 510. For example, during the deployment phase 510, the trained machine learning model 508 executed by the vehicle recommendation machine 108 may receive input data 512 related to a series of user interactions. The input data 512 may include one or more user interactions (e.g., data fields) relating to the transaction, such as a product (e.g., good, service, etc.) name, a merchant name, a transaction date, a transaction time, a transaction identification number, a transaction amount, a merchant identification number, a merchant category code, a product description, a transaction description, an image, and more. The machine learning model 508 may output a predicted optimal vehicle recommendation 514 which may then be transmitted to a device of the user (not shown in FIG. 5).

Subsequent to transmitting the notification via the predicted optimal vehicle recommendation 514, notification engagement data 518 may be collected by the vehicle recommendation machine 108 during the monitoring phase 516. The notification engagement data 518 may include a duration from the notification transmission to an interaction with the notification. Interactions may include performing an internet search of the vehicle recommendation, add the vehicle recommendation to a shopping cart, or purchasing the vehicle recommendation, and/or the like. During process 520, the notification engagement data 518 may be analyzed along with the predicted optimal vehicle recommendation 514 and input data 512 to determine an efficacy of the predicted optimal vehicle recommendation 514. In some examples, based on the analysis, the process 500 may return to the training phase 502, where at step 506 values of one or more variables of the model may be adjusted.

The example process 500 described above is provided merely as an example, and may include additional, fewer, different, or differently arranged aspects than depicted in FIG. 5.

FIG. 6 depicts an example of a computer 600, according to certain embodiments. FIG. 6 is a simplified functional block diagram of a computer 600 that may be configured as a device for executing processes or operations depicted in, or described with respect to, FIGS. 1-5, according to exemplary embodiments of the present disclosure. For example, the computer 600 may be configured as user device 102, user data server 110, vehicle data server 112, vehicle inventory server 114, and/or another device according to exemplary embodiments of this disclosure. In various embodiments, any of the systems herein may be a computer 600 (or include multiple computers 600) including, e.g., a data communication interface 620 for packet data communication. The computer 600 may communicate with one or more other computers 600 using the electronic network 625. The network interfaces may include one or more communication interfaces 620. The electronic network 625 may include a wired or wireless network similar to the network 118 depicted in FIG. 1.

The computer 600 also may include a central processing unit (“CPU”), in the form of one or more processors 602, for executing program instructions 624. The user device 102, user data server 110, vehicle data server 112, vehicle inventory server 114, and/or another device according to exemplary embodiments of this disclosure may include one or more processors 602. The computer 600 may include an internal communication bus 608, and a drive unit 606 (such as read-only memory (ROM), hard disk drive (HDD), solid-state disk drive (SDD), etc.) that may store data on a computer readable medium 622, although the computer 600 may receive programming and data via network communications. The computer 600 may also have one or more memories 604 (such as random access memory (RAM)) storing instructions 624 for executing techniques presented herein, although the instructions 624 may be stored temporarily or permanently within other modules of the computer 600 (e.g., one or more processors 602 and/or computer readable medium 622). The user device 102, user data server 110, vehicle data server 112, vehicle inventory server 114, and/or another device according to exemplary embodiments of this disclosure may include one or more memories 604. The computer 600 also may include user input and output ports 612 and/or one or more displays 610 to connect with input and output devices such as keyboards, mice, touchscreens, monitors, displays, etc. The displays of user device 102, user data server 110, vehicle data server 112, vehicle inventory server 114, and/or another device according to exemplary embodiments of this disclosure may include one or more displays 610. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another, e.g., from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to processing data related to a trip, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features. For example, while some of the embodiments above pertain to processing data related to a trip using a machine learning model, any suitable activity may be used. In an exemplary embodiment, instead of or in addition to processing data related to a trip, certain embodiments may include processing data related to planning any event and/or related to services.

It should be appreciated that in the above description of exemplary embodiments of the invention, various features of the invention may sometimes be grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects may lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for transmitting electronic data, the method comprising:
mapping a first user to a first user data set, wherein the first user data set includes user information and one or more interactions made by the first user;
determining a first subset of the one or more interactions based on a first period of time;
parsing the first subset of the one or more interactions, using a trained machine learning model, to determine one or more trends based on one or more attributes of the first subset of the one or more interactions;
determining a first user profile based on the user information and the one or more trends, the first user profile including a user criteria score for each of one or more user criteria;
comparing the user criteria score for each of the one or more user criteria with one or more vehicles, each of the one or more vehicles including a vehicle criteria score for each of one or more vehicle criteria, each vehicle criteria corresponding to a respective user criteria;
based on the comparing, identifying one or more vehicles for the first user at a first time; and
transmitting, to a graphical user interface (GUI) of a user device of the first user, electronic content indicative of the one or more vehicles.

2. The computer-implemented method of claim 1, further including:
identifying one or more updated vehicles at a second time and transmitting electronic content indicative of the one or more updated vehicles at a second period of time or based on updated user interactions.

3. The computer-implemented method of claim 1, further comprising:
receiving a request from the first user to receive the electronic content indicative of the one or more vehicles transmitted to the user device of the first user.

4. The computer-implemented method of claim 1, further comprising:
analyzing the one or more vehicles for the first user and the user information to determine one or more interaction suggestions.

5. The computer-implemented method of claim 4, wherein the one or more interaction suggestions includes a suggestion to share the one or more vehicles with a second user.

6. The computer-implemented method of claim 5, further comprising:
receiving, from the first user and via the GUI, an instruction to share the one or more vehicles with the second user.

7. The computer-implemented method of claim 1, wherein the user information includes location data and user preference data modifiable by the first user.

8. The computer-implemented method of claim 1, wherein the one or more interactions made by the first user are continuously updated and parsed in real-time by the trained machine learning model.

9. The computer-implemented method of claim 1, wherein the one or more attributes include one or more of location, amount, category, or tier.

10. The computer-implemented method of claim 1, wherein the one or more trends include travel time, travel distance, travel type, or travel routine.

11. A computer-implemented method for transmitting electronic data, the method comprising:
mapping a first user to a first user data set, wherein the first user data set includes user information and one or more interactions made by the first user;
determining a first subset of the one or more interactions based on a first frequency of the one or more interactions made by the first user;
parsing the first subset of the one or more interactions, using a trained machine learning model, to determine one or more trends based on one or more attributes of the first subset of the one or more interactions;
determining a first user profile based on the user information and the one or more trends, the first user profile including a user criteria score for each of one or more user criteria;
comparing the user criteria score for each of the one or more user criteria with one or more vehicles, each of the one or more vehicles including a vehicle criteria score for each of one or more vehicle criteria, each vehicle criteria corresponding to a respective user criteria;
based on the comparing, identifying one or more relevant vehicles for the first user at a first time;
transmitting, to a graphical user interface (GUI) of a user device of the first user, electronic content indicative of the one or more relevant vehicles;
receiving a signal comprising updated interaction information for the first user;
parsing the updated interaction information to determine updated one or more trends; and
modifying the first user profile based on the updated one or more trends.

12. The computer-implemented method of claim 11, further including:
identifying one or more updated vehicles at a second time and transmitting electronic content indicative of the one or more updated vehicles based on a second frequency of the one or more interactions or based on updated user interactions.

13. The computer-implemented method of claim 11, further comprising:
receiving a request from the first user to receive the electronic content indicative of the one or more vehicles transmitted to the user device of the first user.

14. The computer-implemented method of claim 11, further comprising:
analyzing the one or more vehicles for the first user and the user information to determine one or more interaction suggestions.

15. The computer-implemented method of claim 14, wherein the one or more interaction suggestions includes a suggestion to share the one or more vehicles with a second user.

16. The computer-implemented method of claim 15, further comprising:
receiving, from the first user and via the GUI, an instruction to share the one or more vehicles with the second user.

17. The computer-implemented method of claim 11, wherein the user information includes location data and user preference data modifiable by the first user.

18. The computer-implemented method of claim 11, wherein the one or more interactions made by the first user are continuously updated and parsed in real-time by the trained machine learning model.

19. The computer-implemented method of claim 11, further comprising:
identifying updated one or more relevant vehicles for the first user; and
transmitting, to the GUI of the user device, updated electronic content indicative of the updated one or more relevant vehicles.

20. A system for transmitting electronic data, the system comprising:
at least one memory storing instructions; and
at least one processor operatively connected to the at least one memory storing instructions and configured to execute the instructions to perform operations, including:
mapping a first user to a first user data set, wherein the first user data set includes user information and one or more interactions made by the first user;
determining a first subset of the one or more interactions based on a period of time;
parsing the first subset of the one or more interactions, using a trained machine learning model, to determine one or more trends based on one or more attributes of the first subset of the one or more interactions;
determining a first user profile based on the user information and the one or more trends, the first user profile including a user criteria score for each of one or more user criteria;
comparing the user criteria score for each of the one or more user criteria with one or more vehicles, each of the one or more vehicles including a vehicle criteria score for each of one or more vehicle criteria, each vehicle criteria corresponding to a respective user criteria;
based on the comparing, identifying one or more vehicles for the first user; and
transmitting, to a graphical user interface (GUI) of a user device of the first user, electronic content indicative of the one or more vehicles.
